(19) United States
(12) Patent Application Publication
(10) Pub. No.: US 2026/0217100 A1
(43) Pub. Date: Jul. 30, 2026

(54) VEHICLE CHASSIS SUPPORTING POWER SUPPLY MODULE

(71) Applicant: Daimler Truck North America LLC, Portland, OR (US)

(72) Inventors: Travis BACH, Portland, OR (US); David KISER, Portland, OR (US); Dinesh Reddy KATAMREDDY, Portland, OR (US)

(21) Appl. No.: 19/147,676

(22) PCT Filed: Jan. 12, 2024
(86) PCT No.: PCT/US2024/011480

§ 371 Date: Jul. 11, 2025

Related U.S. Application Data
(60) Provisional application No. 63/439,002, filed on Jan. 13, 2023.

(51) Int. Cl. B60K 1/04; B62D 21/02

(52) U.S. Cl. CPC B60K 1/04; B62D 21/02

(57) ABSTRACT

This disclosure relates to a vehicle chassis for supporting a power supply module or other components to a vehicle. In some examples, a bottom margin of the chassis rail can include a cutout, and at least a portion of the power supply module can be positioned in the open space associated with the cutout. In addition, the chassis assembly can include one or more liners that can be coupled to one or more sides of the chassis rail and that can reinforce the chassis rail. In some examples, a chassis reinforcement cage can be attached to the chassis assembly and can be positioned beneath the chassis assembly and the power supply module. The chassis reinforcement cage can, among other things, increase the rigidity of the chassis assembly and protect the power supply module.

### BACKGROUND OF THE INVENTION

Vehicles can include various types of electric power supply modules, such as batteries, power cells, and the like. Often these power supply modules can be relatively large. As such, electric power supply modules occupy space relative to the vehicle, and positioning of the electric power supply modules can affect the placement of other vehicle components. In addition, power supply modules can be heavy, which can cause strain on mounting components and can contribute to assembly challenges (e.g., needing additional assembly resources). Furthermore, properties associated with power supply modules (e.g., size, shape, and weight) can create challenges when trying to retrofit existent chassis members (e.g., chassis members associated with vehicles powered by internal combustion engines and/or smaller power supply modules) to support the power supply module.

### DETAILED DESCRIPTION OF DRAWINGS

The present systems and methods that relate to a vehicle chassis for supporting a power supply are described in detail below with reference to these drawings figures.

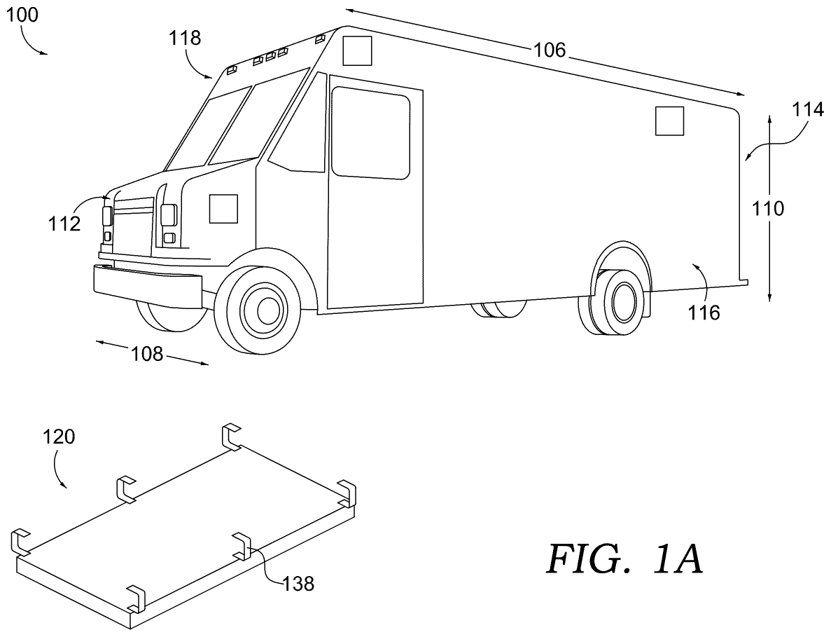

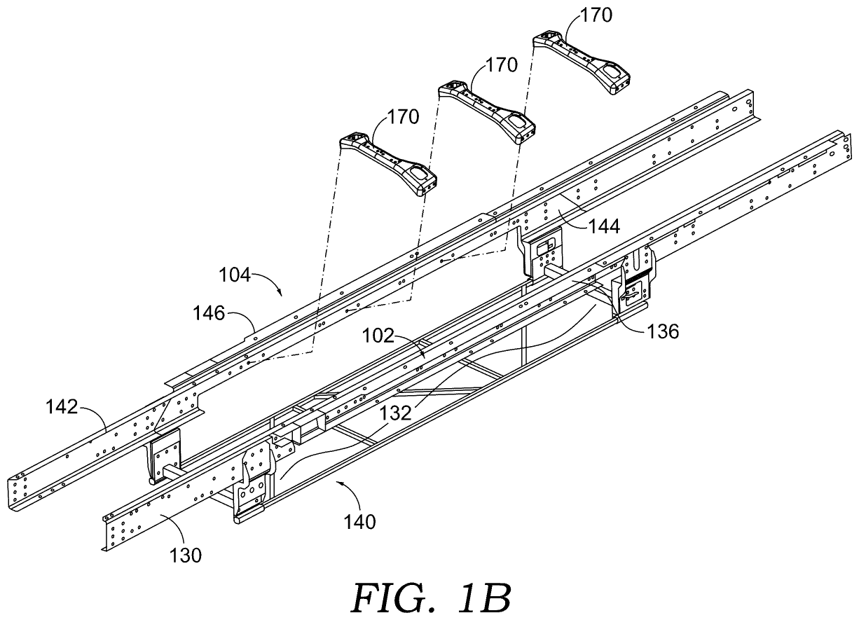

FIG. 1A depicts an example vehicle and power supply module, in accordance with examples of this disclosure.

FIG. 1B depicts chassis assemblies, in accordance with examples of this disclosure.

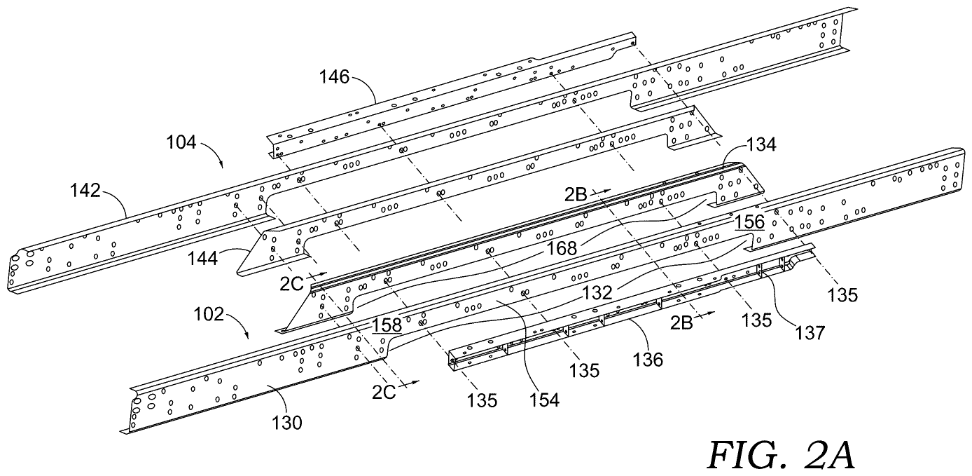

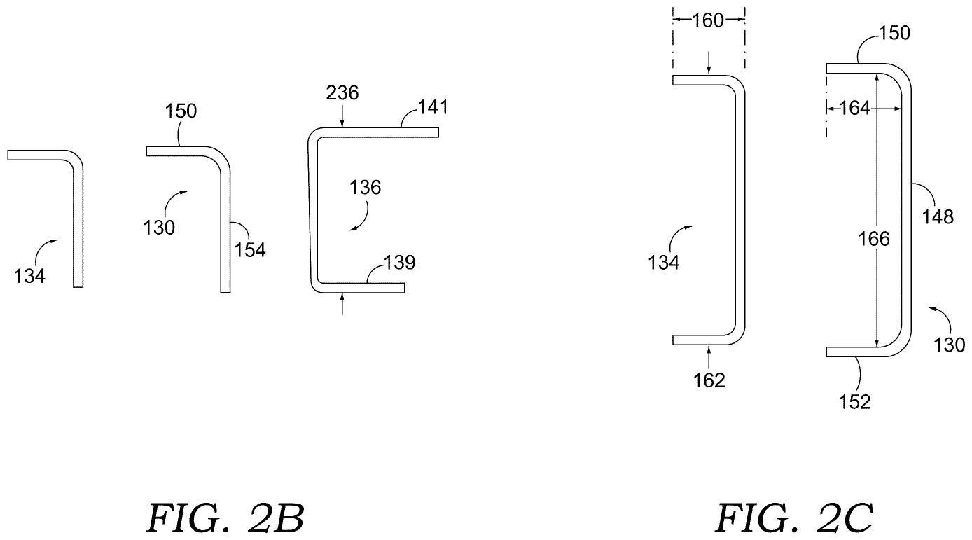

FIG. 2A depicts a disassembled view of chassis assemblies, in accordance with examples of this disclosure.

FIGS. 2B and 2C depict cross sections associated with FIG. 2A, in accordance with examples of this disclosure.

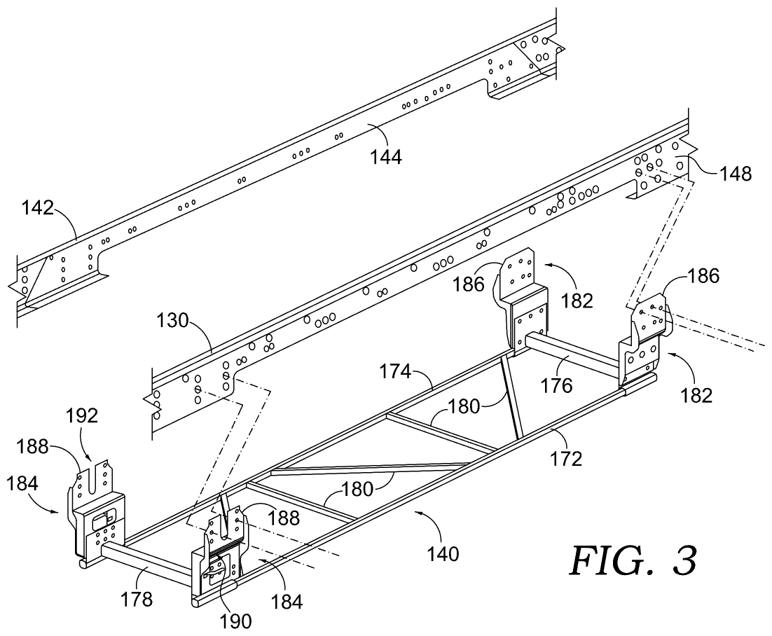

FIG. 3 depicts a chassis reinforcement cage, in accordance with examples of this disclosure.

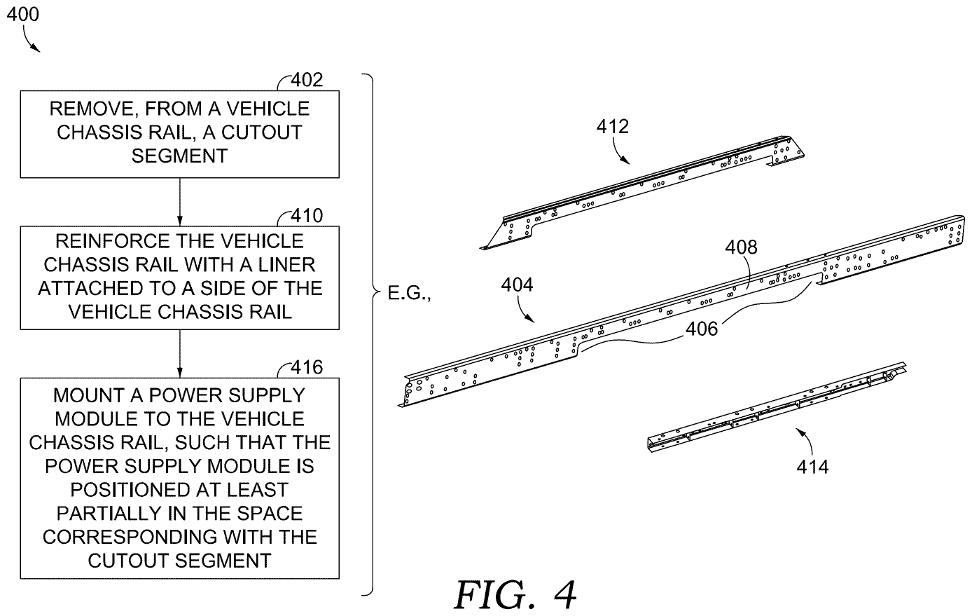

FIG. 4 depicts a flow diagram associated with a method, in accordance with examples of this disclosure.

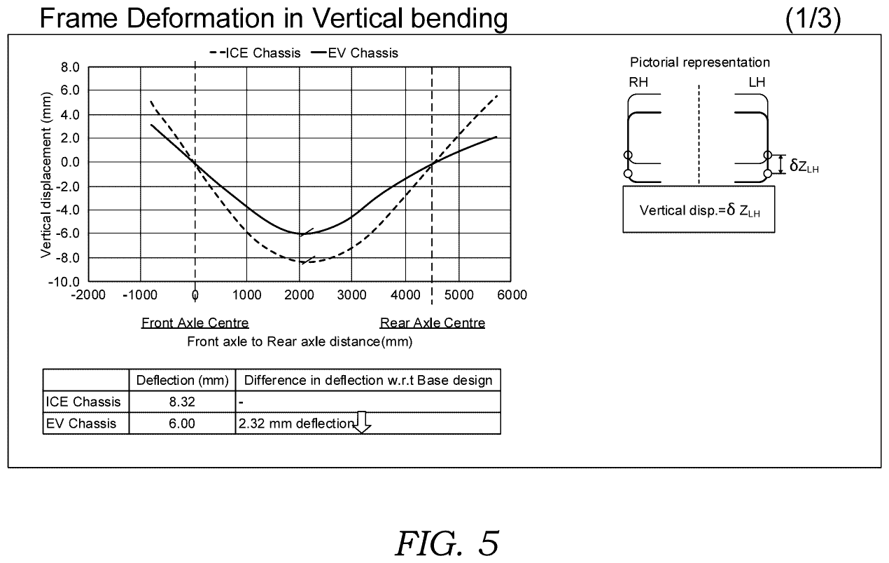

FIGS. 5-7 depict data associated with deflection or deformation of an ICE chassis and an EV chassis during strain testing, in accordance with examples of this disclosure.

### DETAILED DESCRIPTION OF THE INVENTION

This detailed description is related to a vehicle chassis for supporting a power supply module (e.g., high-voltage battery or stack of high-voltage batteries) or other components to a vehicle. In particular, this technology includes a chassis assembly for supporting the power supply module at least partially beneath the chassis of the vehicle, while also providing sufficient ground clearance (e.g., for the power supply module(s) and/or other supporting parts of the assembly). For example, the chassis can include a chassis rail (e.g., in a ladder-style chassis) extending in a longitudinal orientation of the vehicle, and a bottom margin of the chassis rail can include a cutout (e.g., portion of the chassis rail that has been removed). In at least some examples, at least a portion of the power supply module can be positioned in the open space associated with the cutout, when the power supply module is mounted to, and positioned below, the chassis rail. In at least some examples, the chassis assembly can include one or more liners that can be coupled to one or more sides of the chassis rail and that can reinforce the chassis rail (e.g., to reduce stress associated with the cutout). In addition, the one or more liners can provide mounting surfaces to support, and attach to, the power supply module. In some examples, a chassis reinforcement cage can be attached to the chassis assembly and can be positioned beneath the chassis assembly and the power supply module. The chassis reinforcement cage can, among other things, increase the rigidity of the chassis assembly and protect the power supply module.

Having generally described some examples, additional features are now described. Attaching a power supply module (e.g., battery or battery stack) to a vehicle chassis can present various challenges. For example, power supply modules are often relatively large and heavy and include a boxy encasement. As such, mounting a power supply module to the vehicle can create ground clearance issues, such as for the power supply module and/or for parts displaced by the power supply module. In addition, mounting the power supply module to the vehicle can add stress to the mounted-to components, especially in examples in which the mounted-to components have been modified to accommodate the power supply module. As such, examples of the present disclosure include a chassis rail (e.g., frame rail) with a cutout that accommodates the power supply module, and the chassis rail is combined with one or more liners for reinforcement. In addition, in some examples, a reinforcement cage can be mounted below the chassis rail and below the power supply module to increase the rigidity of the chassis assembly and protect the power supply module. The terms “chassis rail” and “frame rail” are used throughout, and in some examples, the terms are interchangeable. Stated differently, a chassis rail can be referred to as a frame rail, and vice versa.

As used herein, a power supply module can include various subject matter, such as a high-voltage battery (e.g., a single battery or a stack of batteries), cooling components, low-voltage components, safety systems (e.g. crash detection sensors, interlock components), power-distribution units (including circuit protection, sensors, contactors/relays, circuit boards, and the like), inverters, brake resistors, charging modules and power take-off modules.

In at least some examples, a chassis assembly for a vehicle includes a chassis rail, which can extend in a longitudinal orientation of the vehicle. Often, a vehicle includes two chassis rails that extend in the longitudinal orientation and that are connected by cross members. In some instances, the chassis rail can include a C-channel (e.g., including a web connected to a first flange and a second flange). In addition, the chassis rail can include, along the bottom of the chassis rail, a cutout. That is, in an example where the chassis rail includes a C-channel with a web, a top flange, and a bottom flange, a section of the bottom flange can be removed along with a portion of the web, thereby leaving a partial web with the top flange. In some instances, the shape of the section removed can correspond with the profile shape of a power supply module, and when the power supply module is mounted to the chassis assembly, at least a portion of the power supply module can be positioned in the cutout. The cutout can, among other things, allow the power supply module to be mounted higher, relative to the frame, which can advantageously increase the ground clearance associated with the power supply module.

In examples, one or more liners can be coupled to the chassis rail. Among other things, the one or more liners can serve to reinforce the chassis rail to accommodate for increased load (e.g., based on the power supply module and associated componentry) and to decrease stress (e.g., based on the vehicle body and other assemblies mounted to the chassis rail). That is, based at least in part on the cutout and/or the additional load associated with the power supply module, the chassis rail can be subjected to various strains or forces (e.g., bending, lateral, torsional, etc.), and the one or more liners can provide reinforcement.

In some examples, the one or more liners can include an inner liner that is attached to the inner or medial side of the chassis rail (e.g., on the side closer to, or facing towards, the longitudinal midline of the vehicle). The inner liner can include an elongated beam or rail that attaches at multiple locations to the chassis rail. For example, the inner liner can include a C-channel that nests within the channel of the chassis rail. The inner liner can also, in some instances, include a cutout that corresponds with the shape of the cutout of the chassis rail. In addition to reinforcing the chassis rail, the inner liner can provide a mounting structure for one or more other components of the vehicle. For example, one or more cross members can mount to the inner liner and connect the chassis rails to one another.

In some examples, the one or more liners can include an outer liner that is attached to the outer or lateral side of the chassis rail (e.g., on the side facing away from the longitudinal midline of the vehicle). The outer liner can include an elongated beam or rail that attaches at multiple locations to the chassis rail. For example, the outer liner can include a C-channel that attaches, above the cutout, to the partial web of the chassis rail. In some instances, the outer liner can include one or more reinforcement gussets (e.g., webs affixed in the channel of the outer liner). In addition to reinforcing the chassis rail, the outer liner can provide a mounting structure for one or more other components of the vehicle. For example, in some instances, the power supply module can mount to a lower flange of the outer liner. In some examples, a C-shaped battery-mounting bracket can attach to an upper mounting surface of the lower flange, such that the power supply module is “hung” off of the outer liner, and also positioned in the cutout.

In at least some examples, the chassis assembly can include the chassis rail with a cutout. The chassis assembly can include (in addition to the chassis rail with a cutout) an inner liner, and no outer liner. The chassis assembly can include (in addition to the chassis rail with a cutout) an outer liner and no inner liner. The chassis assembly can include (in addition to the chassis rail with a cutout) an inner liner and an outer liner. The chassis assembly can, in some examples, include the chassis rail with a cutout and not include any liner.

In at least some examples, subject matter of this disclosure includes a chassis reinforcement cage attached to the chassis assembly. For example, the chassis reinforcement cage can attach to the chassis assembly (e.g., to the chassis rail, to the inner liner, and/or to the outer liner) and can extend down below the chassis assembly. In addition, the cage can include frame members that extend around (e.g., below, to the sides, etc.) a power supply module mounted to the chassis assembly. In some examples, the chassis reinforcement cage can include side rails that generally, longitudinally align with the chassis assembly and can include one or more cross members that extend between the side rails. The chassis reinforcement cage can, among other things, increase the rigidity of the chassis assembly and protect the power supply module. In addition, the chassis reinforcement cage can, in some examples, include a bolt-on construction that allows at least a portion of the chassis reinforcement cage to decouple to provide access for servicing the power supply module and/or other parts of the vehicle.

These and other aspects are described further below with reference to the accompanying drawings. The drawings are merely example implementations, and should not be construed to limit the scope of the claims. For example, while the example vehicle or parts shown may be for a certain type of vehicle (e.g., box truck), aspects described herein can be used with a variety of other vehicle sizes, classes, and types (e.g., light duty trucks and other passenger vehicles, heavy-duty trucks, medium-duty trucks, buses, trams, carts, and the like). In addition, the subject matter of this disclosure can be used with internal combustion engine (“ICE”) vehicles, electric vehicles (“EV”), battery electric vehicles (“BEV”); hybrid electric vehicles (“HEV”), plug-in electric vehicles (“PHEV”), and with fuel-cell electric vehicles (“FCEV”), among others.

Referring now to FIG. 1A, FIG. 1A depicts an example vehicle 100. In general, the vehicle 100 can be associated with various axes or orientations, including a longitudinal axis 106, a transverse axis 108 (or lateral), and a vertical axis 110. In addition, the vehicle 100 generally includes a front 112, a back 114, a left side 116, and a right side 118. In examples, and referring to FIG. 1B, chassis assemblies 102 and 104 extend in the longitudinal axis 106, from near the front 112 to near the back 114. In addition, in some instances, it can be desirable to mount a power supply module 120 (FIG. 1A) to the vehicle 100.

In examples of the present disclosure, the power supply module 120 can include a single power supply module or a stack of power supply modules. In some examples, the power supply module 120 can include an encasement that encloses a volume, which houses multiple power cells and other power components (not shown). The encasement can include various structures and components, and in at least one example, the encasement includes one or more overhangs, which can connect to a battery-mounting bracket for attachment to the chassis assemblies 102 and 104. In addition, the power supply module 120 (e.g., the encasement) can include a generally box-like shape.

In examples, a power supply module 120 or stack, and its related componentry (e.g., coolant lines, power electronics, power cables, etc.), or any combination of these, can be associated with a relatively large spatial volume when assembled with the vehicle, and as such, a location of one or more of these components can affect the placement of other components on the vehicle 100. In addition, on account of the spatial volume associated with the power supply module, the available mounting locations can be limited and/or can create ground-clearance issues. These components can also be relatively heavy, which can also affect mounting location, mounting components, and assembly method. At least some examples of this disclosure are related to an assembly for mounting a power supply module and/or a power supply-module stack to the vehicle 100.

Referring to FIG. 1B, examples of this disclosure are related to a vehicle chassis for supporting a power supply module 120 (e.g., high-voltage battery or stack of high-voltage batteries) connected to a vehicle. For example, the vehicle chassis can include the chassis assemblies 102 and 104, which can support the wheels and suspension, body, and other parts of the vehicle. In addition, the chassis assemblies 102 and 104 can support the power supply module 120 at least partially beneath the chassis of the vehicle. In general, a vehicle can include both chassis assemblies, one on the left and one on the right. Parts of this disclosure may, for brevity, describe one of the chassis assemblies without explicitly describing the other chassis assembly, and it can be understood that the same disclosure can apply to the other chassis assembly.

The chassis assemblies 102 and 104 are depicted in FIG. 1B, and a deconstructed view is provide in FIG. 2A. In examples, the chassis assembly 102 can include a chassis rail 130 having a cutout 132, and when the power supply module 120 is mounted to the chassis assembly 102, at least a portion of the power supply module 120 can be positioned in the cutout 132.

In addition, the chassis assembly 102 can include one or more liners 134 and 136 that can be coupled to one or more sides of the chassis rail 130 and that can reinforce the chassis rail 130. Note that in FIG. 1B, the inner liner 134 associated with the chassis assembly 102 is obscured from view (e.g., nested inside the channel of the chassis rail 130), and the inner liner 144 associated with the chassis rail 142 (of the chassis assembly 104) can be seen. In addition, the one or more liners can provide mounting surfaces to support, and attach to, the power supply module 120 (e.g., to attach to a battery-mounting bracket 138).

In some examples, a chassis reinforcement cage 140 can be attached to the chassis assemblies 102 and 104 and can be positioned beneath the chassis assemblies 102 and 104 and the power supply module 120. The chassis reinforcement cage 140 can, among other things, increase the rigidity associated with the chassis assemblies 102 and 104 and can protect the power supply module 120. The chassis reinforcement cage 140 is depicted in FIG. 1B, and another view of the chassis reinforcement cage 140 is depicted in FIG. 3.

Referring to FIG. 2A, the chassis assembles 102 and 104 are illustrated, and at least some of the components of each chassis assembly 102 and 104 are depicted. For example, the first chassis assembly 102 can include the chassis rail 130, an inner liner 134, and an outer liner 136. In addition, the second chassis rail 104 can include a chassis rail 142, an inner liner 144, and an outer liner 146.

The chassis rail 130 can include an elongated beam or rail structure. In at least some examples, the chassis rail 130 includes a C-channel (e.g., FIG. 2C), which can include a web 148, a first flange 150 (e.g., top flange), and a second flange 152 (e.g., bottom flange). The chassis rail 130 can be constructed or fabricated in various manners, such as be extrusion, bending or forming, casting, welding, and the like.

In addition, the chassis rail 130 can include a cutout 132, which can extend along a part of a section of the bottom of the chassis rail 130. In examples, “C-channel” can be used to describe a beam member in general, and does not necessarily indicate that the beam must include a “C” profile along the entire length of the beam. In examples, a beam that includes a first flange, a second flange, and a web between the first and second flanges can be described as a “C-channel,” even where a portion of the beam (e.g., one of the flanges and/or part of the web) has been cut out or otherwise removed, such that the profile of the beam associated with that portion does not include a “C” profile. A C-channel with the first flange, the second flange, and the web can be fabricated using various techniques, such as extruding, bending or forming, welding, casting, and the like.

As used herein, “bottom margin” refers to the bottom-most or lower-most extent of a rail or beam (e.g., the chassis rail 130) along a given section of the rail or beam. Directionally, when referring to the chassis rail, “bottom” refers to the portion of the chassis rail that, as compared to other parts of the chassis rail, is the lower-most portion of the chassis rail when the chassis rail is integrated into a vehicle or would be the lower-most portion of the chassis rail if the chassis rail were to be integrated into a vehicle in an intended manner. A “top margin” refers to an upper-most extent of a rail or beam along a given section. Directionally, when referring to the chassis rail, “top” refers to the portion of the chassis rail that, as compared to other parts of the chassis rail, is the upper-most portion of the chassis rail when the chassis rail is integrated into a vehicle or would be the upper-most portion of the chassis rail if the chassis rail were to be integrated into a vehicle in an intended manner.

A cutout can refer to a portion of the rail that is omitted through fabrication processing (e.g., has been removed or cut away) or omitted based on a design of a casting mold. For example, the cutout 132 can refer to a section of the bottom flange 152 and a portion of the web 148 that have been removed or omitted, thereby leaving a partial web 154 (e.g., FIG. 2B) and the top flange 150. In some instances, the shape of the section removed or omitted for the cutout 132 can correspond with a profile shape of the power supply module 120 (e.g., the shape or profile of the encasement), and when the power supply module 120 is mounted to the chassis assembly, at least a portion of the power supply module 120 can be positioned in the cutout 132. The cutout 132 can, among other things, allow the power supply module 120 to be mounted higher, relative to the frame, which can increase the ground clearance associated with the power supply module 120.

Typically, the chassis rail 130 can be subjected to various forces when installed in a vehicle, such as forces associated with various components (e.g., body and power supply module) mounted to the vehicle and the vehicle driving down the road. As such, the chassis rail 130 could be associated with various hot spots (e.g., near positions 156 and 158) that experience higher levels of strain than other parts of the vehicle, and in some instances, the strain could be higher based on the cutout 132 and power supply module 120. Examples of the present disclosure can include one or more of the liners 134 and 136 to help decrease the strain associated with the chassis assembly 102. In some examples, a chassis assembly can include a chassis rail with a cutout without any liners attached to the chassis rail.

In some examples, the inner liner 134 can attach to the inner or medial side of the chassis rail 130 (e.g., on the side closer to, or facing towards, the longitudinal midline of the vehicle). For instance, various (not all) bolt paths 135 are depicted to help illustrate how, in some examples, the liners 134 and 136 can attach to the chassis rail 130. In some instances, one or more bolt fasteners that affix the liners 134 and 136 to the chassis rail 130 can also affix other parts to the chassis rail 130 (e.g., the brackets 186 and/or 188 described below with respect to FIG. 3).

The inner liner 134 can include an elongated beam or rail that attaches at multiple locations to the chassis rail 130. For example, the inner liner 134 can include a C-channel that nests within the channel of the chassis rail 130. That is, the chassis rail 130 and the inner liner 134 can both include a C-channel, and in some examples, the dimension of the inner liner 134 are conducive to the inner liner 134 nesting in the channel of the chassis rail 130. For example, the inner liner can include a flange width 160 (e.g., FIG. 2C) and web depth 162 that include a size conducive to the inner liner 134 fitting within the channel (e.g., defined by dimensions 164 and 166, which can be a channel depth and channel width, respectively) of the C-channel chassis rail 142.

The inner liner 134 can also, in some instances, include a cutout 168 that corresponds with the shape of the cutout 132 of the chassis rail 130. As such, when the inner liner 134 is coupled to the chassis rail 130, the inner liner 134 may not interfere with the space in which the power supply module 120 is mounted. In addition to reinforcing the chassis rail 130, the inner liner 134 can provide a mounting structure for one or more other components of the vehicle. For example, one or more cross members 170 (FIG. 1B) can mount to (e.g., fasten to) the inner liner 134 and connect the chassis assemblies 102 and 104 to one another.

In some examples, the one or more liners can include an outer liner 136 that is attached to the outer or lateral side of the chassis rail 130 (e.g., on the side facing away from the longitudinal midline of the vehicle). As mentioned above, various (not all) bolt paths 135 are depicted to help illustrate how, in some examples, the liners 134 and 136 can attach to the chassis rail 130. The outer liner 136 can include an elongated beam or rail that attaches at multiple locations to the chassis rail. For example, the outer liner 136 can include a C-channel that attaches, above the cutout 132, to the partial web 154 of the chassis rail. The outer liner 136 can include dimension configured to allow the outer liner 136 to attach to the chassis rail 130 and above the cutout 132 and to the partial web 154. For example, in some instances, the outer liner 136 can include a web depth 236 (e.g., FIG. 2B and measured from the lower flange 139 to an upper flange 141) that is less than or equal to the height of the partial web 154 (e.g., where the height of the partial web 154 is from the bottom edge of the partial web to the upper extent or the upper face on top of the top flange 150). In some instances, the outer liner 136 can include a web depth 236 that is greater than the height of the partial web 154, and an upper extent of the outer liner 136 can extend above the upper extent of the chassis rail, such that the outer liner 136 does not block the opening associated with the cutout (e.g., the lower flange 139 of the outer liner 136 can be positioned horizontally even with the bottom edge of the partial web 154, while the upper flange of the outer liner 136 can be positioned higher than the top flange 150).

In some instances, the outer liner 136 can include one or more reinforcement gussets 137 (e.g., FIG. 2A including webs affixed, such as by welding, in the channel of the outer liner). In addition to reinforcing the chassis rail 130, the outer liner 136 can provide a mounting structure for one or more other components of the vehicle. For example, in some instances, the power supply module 120 can mount to a lower flange 139 of the outer liner. In some examples, a C-shaped battery-mounting bracket 138 can attach to an upper mounting surface of the lower flange 139, such that the power supply module 120 is “hung” off of the outer liner 136, and also positioned in the cutout 132.

As indicated above, a vehicle can include both chassis assemblies 102 and 104. Parts of this disclosure may, for brevity, describe chassis assembly 102 without explicitly describing the other chassis assembly 104 (or vice versa), and it can be understood that the same disclosure can apply to the other chassis assembly 104. In examples, reinforcing the chassis rails 130 and 142 can significantly reduce strain associated with various positions (e.g., 156 and 158) along the chassis rails 130 and 142. In some instances, the chassis rail 130 and 142 can be reinforced with the inner liner 134 and 144, respectively. In some examples, the chassis rail 130 and 142 can be reinforced with the outer liner 136 and 146, respectively. In some examples, the chassis rail 130 and 142 can be reinforced with both the inner liner 134 and 144, respectively, and with the outer liner 136 and 146, respectively.

In at least some examples, the chassis assemblies 102 and 104 can be coupled with one or more other structures, which can also help to mitigate strain associated with the assemblies. For instance, referring to FIG. 3, in some examples the chassis reinforcement cage 140 can be coupled to the chassis assemblies 102 and 104. The chassis reinforcement cage 140 can, among other things, help mitigate strain (e.g., torsional strain) associated with the overall chassis and with the subassemblies of the chassis. In addition, the chassis reinforcement cage 140 can provide a protective structure around the power supply module 120 and can, in some examples, support damping structures or other structures to mitigate impact against the power supply module 120.

In some examples, the chassis reinforcement cage 140 can attach to the chassis assembly (e.g., to the chassis rail, to the inner liner, and/or to the outer liner) and can extend down below the chassis assembly. In addition, the cage 140 can include an assembly of frame members (e.g., tubular members or L-channel or C-channel) that extend around (e.g., below, to the sides, etc.) the power supply module 120 mounted to the chassis assembly. In some examples, the chassis reinforcement cage 140 can include side rails 172 and 174 and a front cross member 176 and a rear cross member 178, which collectively can form a rectangular frame. In addition, the cage 140 can include one or more intra cross members 180 (diagonal or cross) that extend from one side rail 172 to the other side rail 174 that can impart additional rigidity to the cage 140.

The chassis reinforcement cage 140 can attach to the chassis assemblies 102 and 104 in various manners. In at least one example, the cage 140 includes front mounting brackets 182 that are attached to the cross member 176 and rear mounting brackets 184 that are attached to the cross member 178. In addition, each of the mounting brackets 182 and 184 can include a mounting plate 186 and 188, respectively, which can be fastened to the chassis assemblies. The mounting plates 186 and 188 could be configured to attach to various parts of the chassis assemblies, and in one example, the mounting plates 186 and 188 are configured to attach to the web (e.g., 148) of the chassis rails 130 and 142. Depending on the configuration of the inner liner (e.g., 144 and the inner liner 134 is obscured from view in FIG. 3), the fasteners attaching the mounting plates 186 and 188 can also connect to the inner liner. That is, the same bolt fasteners can extend through, and couple, both the inner liner and the mounting plates to the chassis rail.

In addition, the mounting plates 186 and 188 can include one or more bends (e.g., 190) that operate to wrap around the lower flange (e.g., 152) of the chassis rail 130 and 142 and align the side rails 172 and 174 directly beneath the chassis assemblies 102 and 104, which can provide improved strain resistance. In at least some examples, the mounting brackets 182 and 184 can include elements to improve assembly and tool clearance associated with the chassis. For example, the mounting plates 188 (e.g., rear) can include, between the fastener through holes, a slot 192 that can help provide useful clearance when assembling cross members of the chassis.

In at least some examples, the lower frame of the chassis reinforcement cage (e.g., rectangular frame with side rails 172 and 174 and cross members) can include a bolt-on construction that fastens to the mounting brackets. As such, at least a portion of the chassis reinforcement cage can decouple to provide access for servicing the power supply module and/or other parts of the vehicle. In addition, the chassis support cage can be robust enough to support the weight of the power supply module, such as to provide supplemental and/or backup support (in addition to the battery-mounting brackets).

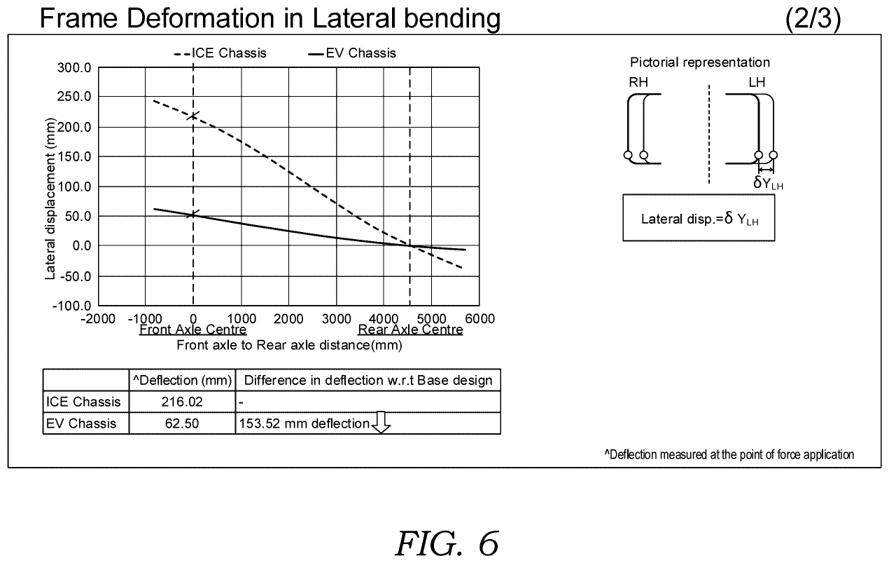

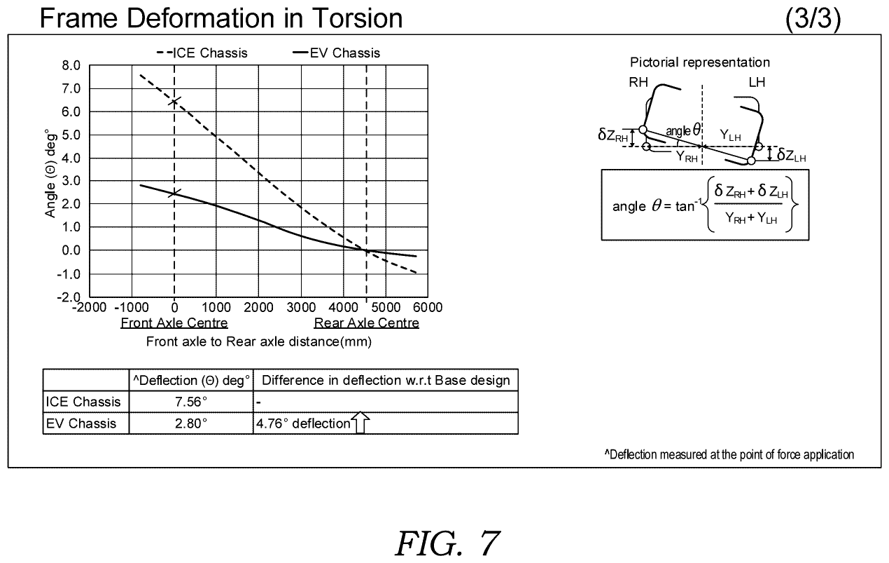

In examples, the chassis assemblies 102 and 104 and the reinforcement cage 140 can reduce strain associated with the chassis rails 130 and 142 and can increase the likelihood of a chassis meeting performance standards or criteria. For example, FIGS. 5-7 depict various information comparing performance of a standard chassis rail (e.g., internal combustion engine (ICE) chassis) and a chassis rail (EV chassis) that is associated with an inner liner, an outer liner, and the reinforcement cage. As depicted by FIG. 5, in at least some test, the EV chassis was associated with smaller vertical deflection (e.g., between the axles), as compared with at least one ICE chassis. As depicted by FIG. 6, in at least some test, the EV chassis was associated with smaller lateral deflection (e.g., between the axles), as compared with at least one ICE chassis. As depicted by FIG. 7, in at least some test, the EV chassis was associated with smaller torsional deformation (e.g., between the axles), as compared with at least one ICE chassis.

At least some examples of the present disclosure are related to method for coupling a power supply module to a vehicle, such as when manufacturing the vehicle or when retrofitting a vehicle. For example, referring to FIG. 4, a flow diagram outlines steps that could be performed as part of a method 400 for coupling a power supply module to a vehicle. In describing the method 400, reference may be had to parts described with respect to other figures, and this is for example purposes, and is not to be limiting. In some examples, one or more operations associated with the method 400 can be automated, such as by relying on instructions stored in non-transitory memory of, e.g., a computing device.

A computing device can include an interconnected system that directly or indirectly couples the following devices: memory, one or more central processing units (CPUs), one or more graphics processing units, a communication interface, input/output (I/O) ports, input/output components, a power supply, one or more presentation components (e.g., display(s)), and one or more logic units. A computing device can include various types of devices, and distinction is not made between such categories as “workstation,” “server,” “laptop,” “desktop,” “tablet,” “client device,” “mobile device,” “hand-held device,” “electronic control unit (ECU),” “virtual reality system,” and/or other device or system types, as all are contemplated within the scope of the computing device.

The memory may include any of a variety of computer-readable media. The computer-readable media may be any available media that may be accessed by the computing device. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) may be configured to execute at least some of the computer-readable instructions to control one or more components of the computing device to perform one or more of the methods and/or processes described herein (e.g., associated with the method 400). The CPU(s) may include any type of processor, and may include different types of processors depending on the type of computing device implemented (e.g., processors with fewer cores for mobile devices and processors with more cores for servers). The computing device may include one or more CPUs in addition to one or more microprocessors or supplementary co-processors, such as math co-processors.

The method 400 can include, at 402, removing, from a vehicle chassis rail, a cutout segment. For example, FIG. 4 depicts a pictorial of the chassis rail 404 with the cutout 406. In examples, the vehicle chassis rail can include, after removal of the cutout segment, a channel having a partial web 408 and a space corresponding with the cutout segment. In some examples, the cutout segment can be removed while the chassis rail is installed in a vehicle (e.g., as part of a process to retrofit the vehicle to support a power supply module).

At 410, the method 400 can include reinforcing the vehicle chassis rail with a liner attached to a side of the vehicle chassis rail. For example, the chassis rail 404 can be reinforced with at least one of the inner liner 412 or the outer liner 414.

In examples, the method 400 can include, at 416, mounting a power supply module to the vehicle chassis rail, such that the battery is positioned at least partially in the space corresponding with the cutout segment. For example, as explained in other portions of this disclosure, a battery-mounting bracket (e.g., 138) can be fastened to a lower flange of the outer line 414 or to another part of the chassis assembly.

The method 400 can include other steps that are not listed in the flow diagram of FIG. 4. For example, the method 400 can include removing, from the liner (e.g., the inner liner 412), a second cutout segment corresponding with the first cutout segment. In at least some examples, the method 400 can include nesting the liner (e.g., inner liner 412) in the channel of the vehicle chassis rail. In addition, the method 400 can include, in some examples, mounting, below the vehicle chassis rail and below the power supply module, a chassis reinforcement cage. The chassis reinforcement cage can be fastened to the chassis rail 402, as well as to the opposing chassis rail on the other side.

### EXAMPLE CLAUSES

Clause 1. A vehicle comprising: a first chassis rail extending in a longitudinal orientation of the vehicle and comprising a first medial side facing towards a longitudinal midline of the vehicle, a first lateral side facing away from the longitudinal midline of the vehicle, and a first bottom margin, wherein the first chassis rail comprises a first cutout that, along at least a part of a first section of the first chassis rail, extends through the first bottom margin and into at least a portion of the first medial side and into at least a portion of the first lateral side; a second chassis rail extending in the longitudinal orientation of the vehicle and comprising a second medial side facing the longitudinal midline of the vehicle, a second lateral side facing away from the longitudinal midline of the vehicle, and a second bottom margin, wherein the second chassis rail comprises a second cutout that, along at least a part of a second section of the second chassis rail, extends through the second bottom margin and into at least a portion of the second medial side and into at least a portion of the second lateral side; one or more power-supply mounting brackets affixed to the first chassis rail and to the second chassis rail; and a power supply module affixed via the one or more power-supply mounting brackets, and positioned at least partially beneath the first chassis rail and the second chassis rail, and at least partially in a first space associated with the first cutout and a second space associated with the second cutout.

Clause 2. The vehicle of clause 1, further comprising: a first inner liner affixed, along at least the part of the first section, to the first medial side; and a first outer liner affixed, along at least the part of the first section, to the first lateral side.

Clause 3. The vehicle of clause 2, wherein: the first section includes a first height extending from a bottom edge of the first section to a top margin of the first section, and the first outer liner includes a C-channel beam comprising a web depth, which is greater than or equal to the first height.

Clause 4. The vehicle of clause 2, wherein: the first section includes a first height extending from a bottom edge of the first section to a top margin of the first section, and the first outer liner includes a C-channel beam comprising a web depth, which is less than or equal to the first height.

Clause 5. The vehicle of any one or more of clause 2 through clause 4, wherein: the first outer liner includes a C-channel beam having a web, an upper flange, and a lower flange; and a mounting bracket of the one or more power-supply mounting brackets is coupled to the lower flange.

Clause 6. The vehicle of any one or more of clause 2 through clause 5, wherein: the first chassis rail comprises a first C-channel beam; and the first inner liner comprises a second C-channel beam that nests in the first C-channel beam.

Clause 7. The vehicle of any one or more of clause 2 through clause 6, wherein the first inner liner comprises a third cutout having dimensions that correspond with the first cutout.

Clause 8. The vehicle of any one or more of clause 2 through clause 7 further comprising, at least one cross member coupled to the first inner liner.

Clause 9. The vehicle of any one or more of clause 1 through clause 8 further comprising, a chassis reinforcement cage mounted to the first chassis rail and to the second chassis rail and positioned beneath the power supply module, the chassis reinforcement cage comprising a frame and one or more cross members extending from one portion of the frame to another portion of the frame.

Clause 10. The vehicle of clause 9 further comprising, at least one cage mounting bracket that attaches the chassis reinforcement cage to the first chassis rail, wherein: the first chassis rail comprises a C-channel beam; the at least one cage mounting bracket comprises a first portion attached to a web of the C-channel beam; and the at least one cage mounting bracket includes a second portion that extends below the first portion and that attaches to the chassis reinforcement cage.

Clause 11. The vehicle of any one or more of clause 2 through clause 10, further comprising: a second inner liner affixed, along at least the part of the second section, to the second medial side; and a second outer liner affixed, along at least the part of the second section, to the second lateral side.

Clause 12. A chassis assembly for a vehicle, the chassis assembly comprising: a C-channel chassis rail comprising: a web; a first flange coupled to a top portion of the web; a second flange coupled to a bottom portion of the web; and a cutout associated with the second flange and a section of the web, such that the web comprises a partial web between the cutout and the first flange; an inner liner nested in a channel of the C-channel chassis rail and against a first side of the partial web; an outer liner affixed to a second side of the partial web that opposes the first side of the partial web; and a power-supply-mounting bracket coupled to at least one of the C-channel chassis rail, the inner liner, or the outer liner.

Clause 13. The chassis assembly of clause 12, wherein the inner liner comprises a second cutout that has dimensions that correspond with the cutout.

Clause 14. The chassis assembly of clause 12 or clause 13, wherein: the outer liner includes a C-channel beam; and the power-supply-mounting bracket is coupled to a lower flange of the C-channel beam.

Clause 15. The chassis assembly of any one or more of clause 12 through clause 14 further comprising, a cage-mounting bracket coupled to the web, the cage-mounting bracket extending past the second flange and comprising a mounting surface configured to attach to a chassis reinforcement cage.

Clause 16. The chassis assembly of clause 15, wherein the cage-mounting bracket is coupled to the web on a same side as the outer liner.

Clause 17. The chassis assembly of clause 15 or clause 16, wherein the chassis reinforcement cage is positioned below the chassis rail.

Clause 18. The chassis assembly of clause 17, wherein the chassis reinforcement cage comprises a side rail that is generally aligned with a longitudinal orientation of the C-channel chassis rail and that is positioned beneath at least a portion of the cutout.

Clause 19. A method comprising: removing, from a vehicle chassis rail, a cutout segment, the vehicle chassis rail comprising, after removal of the cutout segment, a channel having a partial web and a space corresponding with the cutout segment; reinforcing the vehicle chassis rail with a first liner attached to a first side of the vehicle chassis rail; and mounting a power supply module to the vehicle chassis rail, such that the power supply module is positioned at least partially in the space corresponding with the cutout segment.

Clause 20. The method of clause 19 further comprising, removing, from the first liner, a second cutout segment corresponding with the first cutout segment.

Clause 21. The method of clause 19 or clause 20 further comprising, nesting the first liner in the channel of the vehicle chassis rail.

Clause 22. The method of any one or more of clause 19 through clause 21 further comprising, attaching a second liner to a second side of the vehicle chassis rail that opposes the first side of the vehicle chassis rail, such that the vehicle chassis rail is positioned between the first liner and the second liner.

Clause 23. The method of any one or more of clause 19 through clause 22, wherein mounting the power supply module comprises attaching a battery mounting bracket to the first liner, to the second liner, or to the first liner and to the second liner.

Clause 24. The method of any one or more of clause 19 through clause 23 further comprising: mounting, below the vehicle chassis rail and below the power supply module, a chassis reinforcement cage; and attaching the chassis reinforcement cage to a second vehicle chassis rail.

Clause 25. A chassis assembly for a vehicle, the chassis assembly comprising: a first chassis rail and a second chassis rail; the first chassis rail comprising a first cutout and the second chassis rail comprising a second cutout; and a power supply module, wherein at least a first portion of the power supply module is positioned in a first space defined by the first cutout and at least a second portion of the power supply module is positioned in a second space defined by the second cutout.

Clause 26. The chassis assembly of clause 25 further comprising: a first inner liner coupled to the first chassis rail; and a second inner liner coupled to the second chassis rail.

Clause 27. The chassis assembly of clause 26, wherein: the first inner liner comprises a third cutout that is aligned with the first cutout; and the second inner liner comprises a fourth cutout that is aligned with the fourth cutout.

Clause 28. The chassis assembly of any one or more of clause 25 through clause 27 further comprising: a first outer liner coupled to the first chassis rail; and a second outer liner coupled to the second chassis rail.

Clause 29. The chassis assembly of clause 28, wherein: the first outer liner comprises a first lower flange, a first upper flange, and a first web that connects the first lower flange to the first upper flange; and the second outer liner comprises a second lower flange, a second upper flange, and a second web that connects the first lower flange to the first upper flange.

Clause 30. The chassis assembly of clause 29, wherein: the first web is coupled to the first chassis rail; and the second web is coupled to the second chassis rail.

Clause 31. The chassis assembly of clause 30 further comprising: a first power-supply mounting bracket coupled to the first lower flange and to the power supply module; and a second power-supply mounting bracket coupled to the second lower flange and to the power supply module.

Clause 32. The chassis assembly of any one or more of clause 25 through clause 31 further comprising, a chassis reinforcement cage mounted to the first chassis rail and to the second chassis rail.

Clause 33. The chassis assembly of clause 32, wherein the chassis reinforcement cage is positioned beneath the power supply module.

Clause 34. The chassis assembly of clause 33, wherein the chassis reinforcement cage comprises a frame and one or more cross members extending from one portion of the frame to another portion of the frame.

Clause 35. The chassis assembly of any one or more of clause 32 through clause 34 further comprising, at least one cage mounting bracket that attaches the chassis reinforcement cage to the first chassis rail.

Clause 36. The chassis assembly of clause 35, wherein: the first chassis rail comprises a C-channel beam; and the cage mounting bracket comprises a first portion attached to a web of the C-channel beam.

Clause 37. The chassis assembly of clause 36, wherein the cage mounting bracket includes a second portion that extends below the first portion and that attaches to the chassis reinforcement cage.

Clause 38. The chassis assembly of clause 37, wherein the cage mounting bracket includes a bended portion between the first portion and the second portion.

Clause 39. The chassis assembly of any one or more of clauses 32 through clause 38, wherein the chassis reinforcement cage comprises a side rail that is generally aligned with a longitudinal orientation of the first chassis rail and that is positioned beneath at least a portion of the first cutout.

Clause 40. A vehicle comprising the chassis rail of any one or more of clause 25 through clause 39.

Clause 41. A method comprising: forming a first cutout in a first chassis rail of a vehicle; forming a second cutout in a second chassis rail of the vehicle; mounting a power supply module to the first chassis rail such that at least a first portion of the power supply module is positioned in the first cutout; and mounting the power supply module to the second chassis rail such that at least a second portion of the power supply module is positioned in the second cutout.

Clause 42. The method of clause 41, wherein: forming the first cutout comprises cutting away a first portion of the first chassis rail; and forming the second cutout comprises cutting away a second portion of the second chassis rail.

Clause 43. The method of clause 42 further comprising: cutting away the first portion with the first chassis rail installed in the vehicle; and cutting away the second portion with the second chassis rail installed in the vehicle.

Clause 44. The method of any one or more of clause 41 through clause 43, further comprising: reinforcing the first vehicle chassis rail with one or more first liners; and reinforcing the second vehicle chassis rail with one or more second liners.

Clause 45. The method of clause 44, wherein: the one or more first liners comprises a first inner liner; and the one or more second liners comprises a second inner liner.

Clause 46. The method of clause 45 further comprising: nesting the first inner liner in a channel of the first chassis rail; and nesting the second inner liner in a channel of the second chassis rail.

Clause 47. The method of any one or more of clause 44 through clause 46, wherein: the one or more first liners comprises a first outer liner; and the one or more second liners comprises a second outer liner.

Clause 48. The method of any one or more of clause 44 through clause 47 further comprising: mounting a first power-supply mounting bracket to the one or more first liners, wherein the first power-supply mounting bracket is coupled to the power supply module; and mounting a second power-supply mounting bracket to the one or more second liners, wherein the second power-supply mounting bracket is coupled to the power supply module.

Clause 49. The method of any one or more of clause 41 through clause 48 further comprising mounting, below the first chassis rail, below the second chassis rail, and below the power supply module, a chassis reinforcement cage.

Clause 50. The method of clause 49, wherein mounting the chassis reinforcement cage comprises attaching a first cage mounting bracket to the first chassis rail and attaching a second cage mounting bracket to the second chassis rail.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This above detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

1. A vehicle, comprising:
a first chassis rail extending in a longitudinal orientation of the vehicle and comprising:
a first medial side facing towards a longitudinal midline of the vehicle,
a first lateral side facing away from the longitudinal midline of the vehicle,
a first bottom margin,
a first cutout that, along at least a part of a first section of the first chassis rail, extends through the first bottom margin and into at least a portion of the first medial side and into at least a portion of the first lateral side;
a second chassis rail extending in the longitudinal orientation of the vehicle and comprising:
a second medial side facing the longitudinal midline of the vehicle,
a second lateral side facing away from the longitudinal midline of the vehicle,
a second bottom margin,
a second cutout that, along at least a part of a second section of the second chassis rail, extends through the second bottom margin and into at least a portion of the second medial side and into at least a portion of the second lateral side;
one or more power-supply mounting brackets affixed to the first chassis rail and to the second chassis rail; and
a power supply module affixed via the one or more power-supply mounting brackets, and positioned at least partially beneath the first chassis rail and the second chassis rail, and at least partially in a first space associated with the first cutout and a second space associated with the second cutout.

2. The vehicle of claim 1, further comprising:
a first inner liner affixed, along at least the part of the first section, to the first medial side; and
a first outer liner affixed, along at least the part of the first section, to the first lateral side.

3. The vehicle of claim 2, wherein:
the first section includes a first height extending from a bottom edge of the first section to a top margin of the first section, and
the first outer liner includes a C-channel beam comprising a web depth, which is greater than or equal to the first height.

4. The vehicle of claim 2, wherein:
the first section includes a first height extending from a bottom edge of the first section to a top margin of the first section, and
the first outer liner includes a C-channel beam comprising a web depth, which is less than or equal to the first height.

5. The vehicle of claim 2, wherein:
the first outer liner includes a C-channel beam having a web, an upper flange, and a lower flange; and
a mounting bracket of the one or more power-supply mounting brackets is coupled to the lower flange.

6. The vehicle of claim 2, wherein:
the first chassis rail comprises a first C-channel beam; and
the first inner liner comprises a second C-channel beam that nests in the first C-channel beam.

7. The vehicle of claim 2, wherein the first inner liner comprises a third cutout having dimensions that correspond with the first cutout.

8. The vehicle of claim 2 further comprising:
at least one cross member coupled to the first inner liner.

9. The vehicle of claim 1 further comprising:
a chassis reinforcement cage mounted to the first chassis rail and to the second chassis rail and positioned beneath the power supply module, the chassis reinforcement cage comprising a frame and one or more cross members extending from one portion of the frame to another portion of the frame.

10. The vehicle of claim 9 further comprising:
at least one cage mounting bracket that attaches the chassis reinforcement cage to the first chassis rail,
wherein:
the first chassis rail comprises a C-channel beam;
the at least one cage mounting bracket comprises a first portion attached to a web of the C-channel beam; and
the at least one cage mounting bracket includes a second portion that extends below the first portion and that attaches to the chassis reinforcement cage.

11. The vehicle of claim 2, further comprising:
a second inner liner affixed, along at least the part of the second section, to the second medial side; and
a second outer liner affixed, along at least the part of the second section, to the second lateral side.

12. A chassis assembly for a vehicle, comprising:
a C-channel chassis rail comprising:
a web;
a first flange coupled to a top portion of the web;
a second flange coupled to a bottom portion of the web; and
a cutout associated with the second flange and a section of the web, such that the web comprises a partial web between the cutout and the first flange;
an inner liner nested in a channel of the C-channel chassis rail and against a first side of the partial web;
an outer liner affixed to a second side of the partial web that opposes the first side of the partial web; and
a power-supply-mounting bracket coupled to at least one of the C-channel chassis rail, the inner liner, or the outer liner.

13. The chassis assembly of claim 12, wherein the inner liner comprises a second cutout that has dimensions that correspond with the cutout.

14. The chassis assembly of claim 12, wherein:
the outer liner includes a C-channel beam; and
the power-supply-mounting bracket is coupled to a lower flange of the C-channel beam.

15. The chassis assembly of claim 12 further comprising:
a cage-mounting bracket coupled to the web, the cage-mounting bracket extending past the second flange and comprising a mounting surface configured to attach to a chassis reinforcement cage.

16. The chassis assembly of claim 15, wherein the cage-mounting bracket is coupled to the web on a same side as the outer liner.

17. The chassis assembly of claim 15, wherein the chassis reinforcement cage is positioned below the C-channel chassis rail.

18. The chassis assembly of claim 17, wherein the chassis reinforcement cage comprises a side rail that is generally aligned with a longitudinal orientation of the C-channel chassis rail and that is positioned beneath at least a portion of the cutout.

19. A method comprising:
removing, from a vehicle chassis rail, a first cutout segment, the vehicle chassis rail comprising, after removal of the first cutout segment, a channel having a partial web and a space corresponding with the first cutout segment;
reinforcing the vehicle chassis rail with a first liner attached to a first side of the vehicle chassis rail; and
mounting a power supply module to the vehicle chassis rail, such that the power supply module is positioned at least partially in the space corresponding with the first cutout segment.

20. The method of claim 19 further comprising:
removing, from the first liner, a second cutout segment corresponding with the first cutout segment.

21. The method of claim 19 further comprising:
nesting the first liner in the channel of the vehicle chassis rail.

22. The method of claim 19 further comprising:
attaching a second liner to a second side of the vehicle chassis rail that opposes the first side of the vehicle chassis rail, such that the vehicle chassis rail is positioned between the first liner and the second liner.

23. The method of claim 22, wherein mounting the power supply module comprises attaching a battery mounting bracket to the first liner, to the second liner, or to the first liner and to the second liner.

24. The method of claim 19 further comprising:
mounting, below the vehicle chassis rail and below the power supply module, a chassis reinforcement cage; and
attaching the chassis reinforcement cage to a second vehicle chassis rail.

25.-50. (canceled)
